(19) United States
(12) Patent Application Publication
(10) Pub. No.: US 2008/0197995 A1
(43) Pub. Date: Aug. 21, 2008

(54) METHOD FOR INSPECTING WHEEL STATE MONITORING SYSTEM, WHEEL STATE MONITORING SYSTEM, AND RECEIVER

(75) Inventor: Yuji TAKI, Nishikamo-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/028,291

(22) Filed: Feb. 8, 2008

(30) Foreign Application Priority Data
Feb. 16, 2007 (JP) 2007-036920

(51) Int. Cl. B60C 23/00

(52) U.S. Cl. 340/447

(57) ABSTRACT

A wheel state monitoring system monitors the state of a wheel using a transmitter that wirelessly transmits a signal containing wheel information on the wheel and a receiver that receives the signal and estimates the state of the wheel based on the wheel information. According to a method for inspecting the wheel state monitoring system, it is determined whether the wheel information is appropriately transmitted from the transmitter and received by the receiver. The inspection is performed in a communication state in which it is more difficult for the receiver to receive, as the wheel information, a signal transmitted from the transmitter than in a state of communication between the transmitter and the receiver, which is selected at normal times when the wheel state monitoring system monitors the state of the wheel.

### INCORPORATION BY REFERENCE

The disclosure of Japanese Patent Application No. 2007-036920 filed on Feb. 16, 2007 including the specification, drawings and abstract is incorporated herein by reference in its entirety.

### BACKGROUND OF THE INVENTION

1. Field of the Invention

The invention relates generally to a technology for a wheel state monitoring system that monitors the states of wheels and, more particularly, to a technology for enhancing the accuracy of inspection of the wheel state monitoring system.

2. Description of the Related Art

Systems that monitor the tire-pressure such as a tire-pressure monitoring system (hereinafter referred to as a “TPMS”) have come into widespread use. In such a system, the wheel states such as the air pressures in tires are detected by, for example, sensors provided to respective wheels, and signals indicating the detected wheel states are transmitted to an electronic control unit (hereinafter referred to as an “ECU”) provided in a vehicle body, whereby the tire-pressures are monitored. Before shipment of a vehicle including the system described above, some inspections are performed on the sensors, etc. of the system. Then, it is determined whether shipment of the vehicle to the market is allowed.

For example, Japanese Patent Application Publication No. 2006-1363 (JP-A-2006-1363) describes a tire-pressure monitoring system. It is determined that a malfunction has occurred in the tire-pressure monitoring system, when the reception-time electrical field strength of a signal, transmitted from a tire-pressure detection unit and received by a control unit mounted in a vehicle, is lower than a specified value at the tire-assembly line.

In the TPMS described above, the information from the tire-pressure sensors provided to the respective wheels is transmitted via radio waves to a receiver mounted in the vehicle. Therefore, there are occasions where the states of the radio waves received by the receiver are influenced by the conditions inside and outside the vehicle. Even within the same vehicle, the states of the radio waves received by the receiver vary due to the influence of changes in the condition of the road surface on which the vehicle is traveling, the environment around the vehicle, the position of a seat in the vehicle, the operating states of various electric components mounted in the vehicle, etc.

However, various changes in the environment under which the vehicle is actually used are not taken into account in the inspection performed at the tire-assembly line by determining whether the reception-time electrical field strength of a signal, transmitted from the tire-pressure detection unit and received by the control unit, is lower than the specified value, for example, in the inspection performed in the tire-pressure monitoring system described in JP-A-2006-1363. Therefore, there is room for improvement in the method for inspecting such tire-pressure monitoring system.

### SUMMARY OF THE INVENTION

The invention provides a technology for improving the accuracy of an inspection of a wheel state monitoring system that monitors the wheel state.

A first aspect of the invention relates to a method for inspecting a wheel state monitoring system that monitors the state of a wheel using a transmitter that wirelessly transmits a signal containing wheel information on the wheel and a receiver that receives the signal and estimates the state of the wheel based on the wheel information. According to the first aspect of the invention, an inspection for determining whether the wheel information is appropriately transmitted from the transmitter and received by the receiver is performed in a communication state in which it is more difficult for the receiver to receive, as the wheel information, a signal transmitted from the transmitter than in a state of communication between the transmitter and the receiver, which is selected at normal times when the wheel state monitoring system monitors the state of the wheel.

According to the first aspect of the invention, for example, it is possible to perform an inspection for determining whether the performance and specification of the wheel state monitoring system meet predetermined requirements, in the communication state in which it is more difficult for the receiver to receive, as the wheel information, a signal transmitted from the transmitter than in the state of communication between the transmitter and the receiver, which is selected at normal times. Therefore, it is possible to sort out, as a rejected product, a wheel state monitoring system in which the wheel information is not always transmitted appropriately from the transmitter to the receiver depending on variations in the communication state caused by variations in the environment around the vehicle and use condition of the vehicle. In other words, with the method for inspecting the wheel state monitoring system according to the first aspect of the invention, it is possible to pick up a wheel state monitoring system in which the wheel information is always transmitted appropriately from the transmitter to the receiver even when there are variations in the communication state caused by variations in the environment around the vehicle and use condition of the vehicle. Namely, according to the inspection method described above, it is possible to suppress occurrence of a situation in which the wheel information is not transmitted from the transmitter to the receiver when the wheel state monitoring system is in use. As a result, the accuracy of inspection is enhanced.

In this specification, the “communication state in which it is more difficult for the receiver to receive a signal transmitted from the transmitter” may be a communication state in which there is a possibility that even a signal, which can be received, as the wheel information, by the receiver at normal times cannot be received by the receiver. Also, the state in which “a signal cannot be received by the receiver” includes not only the state in which a signal does not reach the receiver but also the state in which a signal reaches the receiver but the wheel information contained in the signal cannot be appropriately received by the receiver due to a dropout or disruption of a part of the waveform of the signal or due to the influence of noise. The transmitter may be a communication device that is also able to receive a signal, and a receiver may be a communication device that is also able to transmit a signal.

The inspection may be performed with a receiver sensitivity of the receiver reduced to a level below a receiver sensitivity in the communication state selected at normal times. Thus, it is possible to create a simulated communication state in which it is more difficult for the receiver to receive, as the wheel information, a signal transmitted from the transmitter. Also, even when the wheel state monitoring system includes multiple transmitters, it is possible to collectively change the communication state between the receiver and the respective transmitters at once by reducing the receiver sensitivity of the receiver.

The inspection may be performed with a transmission power of the transmitter reduced to a level below a transmission power in the communication state selected at normal times. Thus, it is possible to create a simulated communication state in which it is more difficult for the receiver to receive, as the wheel information, a signal transmitted from the transmitter. Also, the S/N (signal/noise) ratio of a signal that reaches the receiver and read in the receiver is lower than the S/N ratio in the case where the sensitivity is reduced at the receiver. Therefore, the inspection is performed in a more rigorous communication state in which it is further difficult to establish communication between the transmitter and the receiver. Therefore, it is possible to pick up a wheel state monitoring system in which the wheel information is always transmitted appropriately from the transmitter to the receiver even when there are variations in the communication state caused by variations in the environment around the vehicle and use condition of the vehicle.

A second aspect of the invention relates to a wheel state monitoring system that monitors the state of a wheel. The wheel state monitoring system includes: a transmitter that wirelessly transmits a signal containing wheel information on the wheel; a receiver that receives the signal and estimates the state of the wheel based on the wheel information; and a communication state setting unit that sets, when an inspection is performed to determine whether the wheel information is appropriately transmitted from the transmitter and received by the receiver, a communication state in which it is more difficult for the receiver to receive, as the wheel information, a signal transmitted from the transmitter than in a state of communication between the transmitter and the receiver, which is selected at normal times when the wheel state monitoring system monitors the state of the wheel.

According to the second aspect of the invention, for example, it is possible to perform an inspection for determining whether the performance and specification of the wheel state monitoring system meet predetermined requirements, in the communication state in which it is more difficult for the receiver to receive, as the wheel information, a signal transmitted from the transmitter than in the state of communication between the transmitter and the receiver, which is selected at normal times. Therefore, it is possible to sort out, as a rejected product, a wheel state monitoring system in which the wheel information is not always transmitted appropriately from the transmitter to the receiver depending on variations in the communication state caused by variations in the environment around the vehicle and use condition of the vehicle. In other words, with the method for inspecting the wheel state monitoring system according to the first aspect of the invention, it is possible to pick up a wheel state monitoring system in which the wheel information is always transmitted appropriately from the transmitter to the receiver even when there are variations in the communication state caused by variations in the environment around the vehicle and use condition of the vehicle. Namely, according to the inspection method described above, it is possible to suppress occurrence of a situation in which the wheel information is not transmitted from the transmitter to the receiver when the wheel state monitoring system is in use. As a result, the accuracy of inspection is enhanced.

The communication state setting unit may include a receiver sensitivity reduction unit that reduces a receiver sensitivity of the receiver to a level below a receiver sensitivity in the communication state selected at normal times. Thus, it is possible to create a simulated communication state in which it is more difficult for the receiver to receive, as the wheel information, a signal transmitted from the transmitter. Provision of the receiver sensitivity reduction unit in the receiver makes it possible to change the communication state between the receiver and the respective transmitters at once. Because the communication state between the receiver and the respective transmitters can be easily changed at once by the receiver sensitivity reduction unit provided in the receiver, it is possible to reduce cost of the wheel state monitoring system.

The communication state setting unit may include a transmission power limiting unit that reduces a transmission power of the transmitter to a level below a transmission power in the communication state selected at normal times. Thus, it is possible to create a simulated communication state in which it is more difficult for the receiver to receive, as the wheel information, a signal transmitted from the transmitter. Also, the S/N (signal/noise) ratio of a signal that reaches the receiver and read in the receiver is lower than the S/N ratio in the case where the sensitivity is reduced at the receiver. Therefore, the inspection is performed in a more rigorous communication state in which it is further difficult to establish communication between the transmitter and the receiver. Therefore, it is possible to pick up a wheel state monitoring system in which the wheel information is always transmitted appropriately from the transmitter to the receiver even when there are variations in the communication state caused by variations in the environment around the vehicle and use condition of the vehicle.

A third aspect of the invention relates to a receiver that receives a signal which contains wheel information on a wheel and which is wirelessly transmitted from a transmitter, and that estimates the state of the wheel. The receiver includes a communication state setting unit that sets, when an inspection is performed to determine whether the wheel information is appropriately transmitted from the transmitter and received by the receiver, a communication state in which it is more difficult for the receiver to receive, as the wheel information, a signal transmitted from the transmitter than in a state of communication between the transmitter and the receiver, which is selected at normal times when the state of the wheel is monitored.

According to the third aspect of the invention, for example, it is possible to perform an inspection for determining whether the performance and specification of the wheel state monitoring system meet predetermined requirements, in the communication state in which it is more difficult for the receiver to receive, as the wheel information, a signal transmitted from the transmitter than in the state of communication between the transmitter and the receiver, which is selected at normal times. Therefore, it is possible to sort out, as a rejected product, a receiver which cannot always receive the wheel information appropriately from the transmitter depending on variations in the communication state caused by variations in the environment around the vehicle and use condition of the vehicle. In other words, it is possible to pick up a receiver which can always receive the wheel information appropriately from the transmitter even when there are variations in the communication state caused by variations in the environment around the vehicle and use condition of the vehicle. Namely, according to the third aspect of the invention, it is possible to suppress occurrence of a situation in which the wheel information is not transmitted from the transmitter to the receiver when the wheel state monitoring system is in use. As a result, the accuracy of inspection is enhanced.

The communication state setting unit may include a receiver sensitivity reduction unit that reduces a receiver sensitivity of the receiver to a level below a receiver sensitivity in the communication state selected at normal times. Thus, it is possible create a simulated communication state in which it is more difficult for the receiver to receive, as the wheel information, a signal transmitted from the transmitter.

According to the aspects of the invention described above, it is possible to improve the accuracy of an inspection of the wheel state monitoring system.

### BRIEF DESCRIPTION OF THE DRAWINGS

The foregoing and further objects, features and advantages of the invention will become apparent from the following description of example embodiments with reference to the accompanying drawings, wherein the same or corresponding portions will be denoted by the same reference numerals and wherein:

FIG. 1 is a view schematically showing the structure of a vehicle provided with a wheel state monitoring system according to a first embodiment of the invention;

FIG. 2 is a block diagram showing a transmitter according to the first embodiment of the invention;

FIG. 3 is a block diagram showing a receiver according to the first embodiment of the invention;

FIG. 4 is a flowchart for describing a method for inspecting the wheel state monitoring system according to the first embodiment of the invention;

FIG. 5 is a block diagram showing a receiver according to a second embodiment of the invention; and

FIG. 6 is a block diagram showing a transmitter according to the second embodiment of the invention.

### DETAILED DESCRIPTION OF THE EMBODIMENTS

Hereafter, example embodiments of the invention will be described in detail with reference to the accompanying drawings. In the following description, the same or corresponding portions will be denoted by the same reference numerals, and detailed descriptions on the portions having the same reference numerals will be provided only once below.

### First Embodiment of the Invention

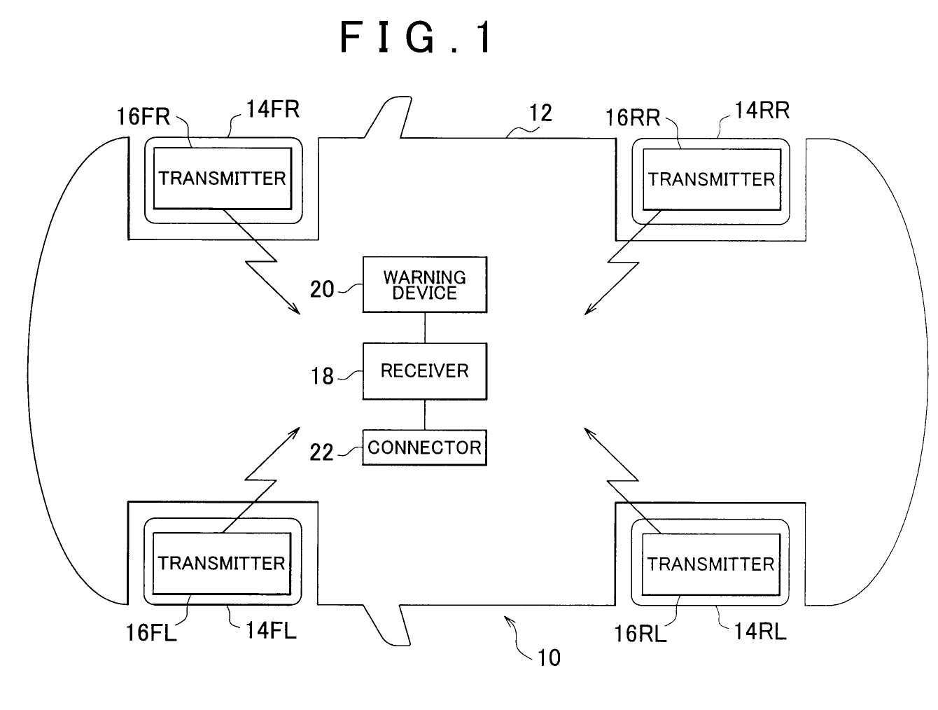

FIG. 1 is a view schematically showing the structure of a vehicle provided with a wheel state monitoring system according to a first embodiment of the invention. A vehicle 10 shown in FIG. 1 includes four wheels 14FR, 14FL, 14RR and 14RL fitted to a vehicle body 12 (hereinafter, the wheels 14FR, 14FL, 14RR and 14RL will be collectively referred to as “wheels 14” where appropriate), a steering device (not shown) that steers the wheels 14FR and 14FL, which function as the steered wheels, a motive power source (not shown) that drives the drive wheels among the wheels 14, etc. Each of the wheels 14 is formed of an aluminum wheel or a steel wheel and a tire.

Transmitters 16FR, 16FL, 16RR and 16RL (hereinafter, the transmitters 16FR, 16FL, 16RR and 16RL will be collectively referred to as “transmitters 16” where appropriate), which transmit signals containing the information on the tire-pressures and the temperatures of the tires, i.e., the wheel information indicating the wheel states, are fitted to the wheels 14FR, 14FL, 14RR and 14RL, respectively. A receiver 18, which receives the signals transmitted from the transmitters 16 and estimates the wheel states, is mounted in the vehicle body 12.

A warning device 20, which gives a warning to a vehicle occupant or a worker based on the estimated wheel states, is connected to the receiver 18. For example, a display unit on which meters are arranged, a warning lamp, a liquid crystal display unit of a car navigation system, or a voice may be used as the warning device 20. In addition, a connector 22 is connected to the receiver 18. The connector 22 connects a diagnostic device, which is used to change the control mode to the later-described inspection mode from the outside of the receiver 18, to the receiver.

The wheel state monitoring system according to the first embodiment of the invention is a tire-pressure monitoring system (TPMS) that includes four transmitters 16 and one receiver 18, which are described above, and that monitors the tire-pressures based on the wheel state information including the tire-pressures transmitted from the transmitters 16 to the receiver 18. Each transmitter 16 according to the first embodiment of the invention is integrated with a tire-pressure regulating valve and then attached to the outer peripheral face of the aluminum wheel.

Transmitter

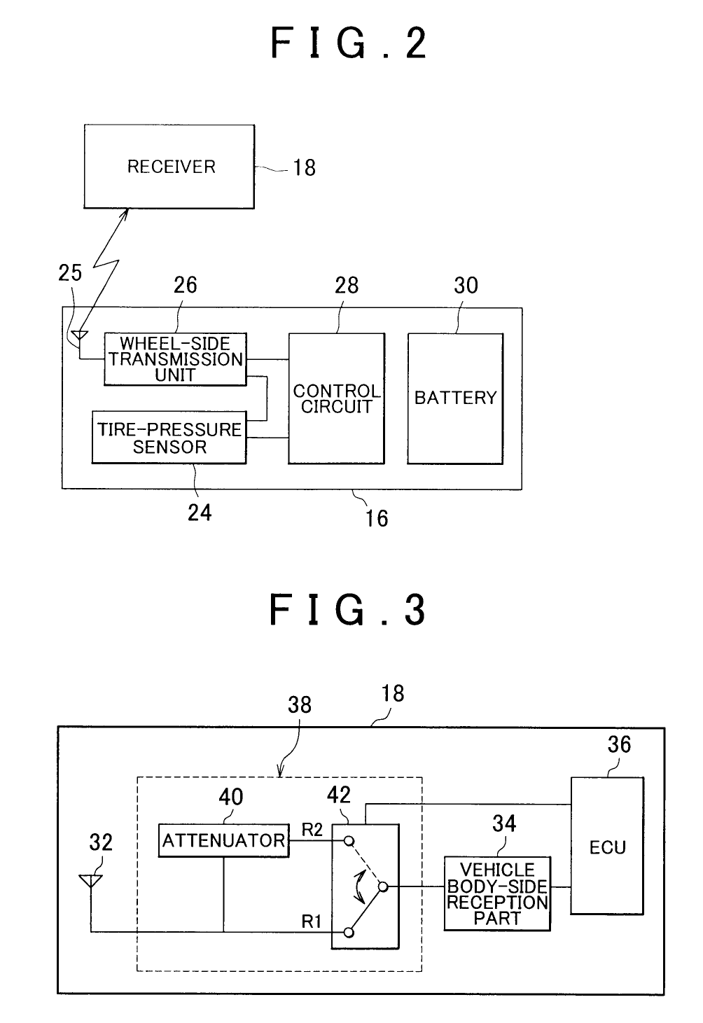

FIG. 2 is a block diagram showing the transmitter 16 according to the first embodiment of the invention. The transmitter 16 integrated with the tire-pressure regulating valve has a housing that houses a tire-pressure sensor 24, an antenna 25, a wheel-side transmission unit 26, a control circuit 28 and a battery 30, as shown in FIG. 2. The transmitter 16 obtains the tire-pressure as the wheel information and periodically transmits signals containing the obtained wheel information to the receiver 18.

The tire-pressure sensor 24 is, for example, a semiconductor sensor. The tire-pressure sensor 24 detects the air pressure within the internal space of the tire and outputs a pressure detection signal indicating the tire-pressure. The wheel-side transmission unit 26 transmits, via radio waves, signals indicating the value detected by the tire-pressure sensor 24 via the antenna 25 to the receiver 18 periodically at predetermined time intervals of, for example, one minute. The control circuit 28 is packaged on, for example, an IC chip, and controls the tire-pressure sensor 24 and the wheel-side transmission unit 26. The battery 30 supplies electric power to the tire-pressure sensor 24, the wheel-side transmission unit 26 and the control circuit 28. The transmitter 16 may further include a temperature sensor that detects the temperature of the air within the internal space of the tire, a longitudinal acceleration sensor, a lateral acceleration sensor, a ground contact pressure sensor, etc.

In the vehicle 10 in the first embodiment of the invention, specific ID codes are provided to storage units of the wheel-side transmission units 26 included in the transmitters 16 fitted to the respective wheels 14. The ID code is used as the identifying information based on which the corresponding wheel 14 is distinguished from the other wheels 14. This allows the wheel-side transmission unit 26 to transmit a signal containing both the tire-pressure information and the ID code information to the receiver 18. Therefore, upon receiving the signal, the receiver 18 determines the wheel 14 which the tire-pressure information pertains to.

Receiver

FIG. 3 is a block diagram showing the receiver 18 according to the first embodiment of the invention. The receiver 18 estimates the wheel states based on signals containing the wheel state information transmitted via radio waves from the transmitters 16. More specifically, the receiver 18 includes an antenna 32 that receives a signal, a vehicle body-side reception unit 34 that receives signals that contain both the tire-pressure information and the ID code information transmitted from the wheel-side transmission units 26 via the antenna 32, and an electronic control unit (hereinafter referred to as an “ECU”) 36 that collectively controls the entirety of the receiver 18. Based on the wheel information of the wheels 14, which is contained in the signals received by the vehicle body-side reception unit 34, the ECU 36 controls the warning device 20 or executes a control in the inspection mode described later.

Arranged between the antenna 32 and the vehicle body-side reception unit 34 is a communication state setting unit 38 that selects the state of communication between the transmitters 16 and the receiver 18 from among multiple communication states. The communication state setting unit 38 according to the first embodiment of the invention includes an attenuator 40 that attenuates the voltages of signals received by the antenna 32 to create the simulated communication state in which it is more difficult for the receiver 18 to receive signals transmitted from the transmitters 16 and/or to determine whether the signals contain the wheel information. In this case, the attenuator 40 serves as a receiver sensitivity-reduction unit that reduces the sensitivity of the receiver 18 to a level below the receiver sensitivity available in the communication state at normal times. Considering variations in the communication state due to variations in the environment around the vehicle, the use condition of the vehicle, etc., an attenuator having a capacity of, for example, approximately 4 dB may be used as the attenuator 40.

The communication state setting unit 38 further includes a switch 42 that selects the circuit, through which signals received by the antenna 32 are input in the vehicle body-side reception unit 34, between a circuit R2 and a circuit R1. Through the circuit R2, the signals received by the antenna 32 are input in the vehicle body-side reception unit 34 via the attenuator 40. Through the circuit R1, the signals received by the antenna 32 are input in the vehicle body-side reception unit 34 without passing through the attenuator 40. The switch 42 is controlled by the ECU 36, whereby the state of communication between the transmitters 16 and the receiver 18 is selected from among multiple communication states.

Even when the wheel state monitoring system includes multiple transmitters 16 as described above, provision of the attenuator 40 in the receiver 18 makes it possible to change the communication state between the receiver 18 and the respective transmitters 16 at once. Because the communication state between the receiver 18 and the respective transmitters 16 can be easily changed at once by the attenuator 40 provided in the receiver 18, it is possible to reduce cost of the wheel state monitoring system.

In the wheel state monitoring system according to the first embodiment of the invention, at normal times when the wheel state monitoring system monitors the wheel states, the switch 42 selects the circuit R1 through which signals received by the antenna 32 are input in the vehicle body-side reception unit 34 without passing through the attenuator 40. In this communication state, signals are transmitted from the transmitters 16 to the receiver 18, and the ECU 36 determines the tire states based on the wheel information received from the vehicle body-side reception unit 34. If the tire-pressure falls below a predetermined value or if the temperature of the air inside the tire exceeds a predetermined value, the ECU 36 actuates the warning device 20 to illuminate a warning lamp or generate a warning beep using a buzzer, thereby notifying a vehicle occupant of the tire state.

Method for inspecting wheel state monitoring system

Next, a method for inspecting the wheel state monitoring system will be described. In some cases, an inspection is performed on the wheel state monitoring system mounted in the vehicle in order to determine whether the wheel information is transmitted appropriately from the transmitters 16 to the receiver 18, before shipment of the vehicle. However, because the information from the tire-pressure sensors 24 fitted to the respective wheels 14 is transmitted, via radio waves, to the receiver 18 mounted in the vehicle 10, the states of the radio waves received by the receiver 18 may be influenced by the conditions inside and outside the vehicle. Therefore, if the inspection of the wheel state monitoring system is performed under a constant environment, for example, at an inspection line in a factory, and also in the communication state in which the circuit R1 is selected (see FIG. 3) and which is selected at normal times when the wheel state monitoring system monitors the wheel states, various changes in the environment under which the vehicle is actually used are not taken into account. Accordingly, there is room for improvement in the inspection method.

Therefore, the following inspection step is included in the inspection method according to the first embodiment of the invention. In the inspection step, the inspection is performed to determine whether the wheel information is appropriately transmitted from the transmitters 16 to the receiver 18 in the communication state in which it is more difficult for the receiver 18 to receive signals transmitted from the transmitters 16 and/or to determine whether the signals contain the wheel information than in the state of communication between the transmitters 16 and the receiver 18, which is selected at normal times when the wheel state monitoring system monitors the wheel states.

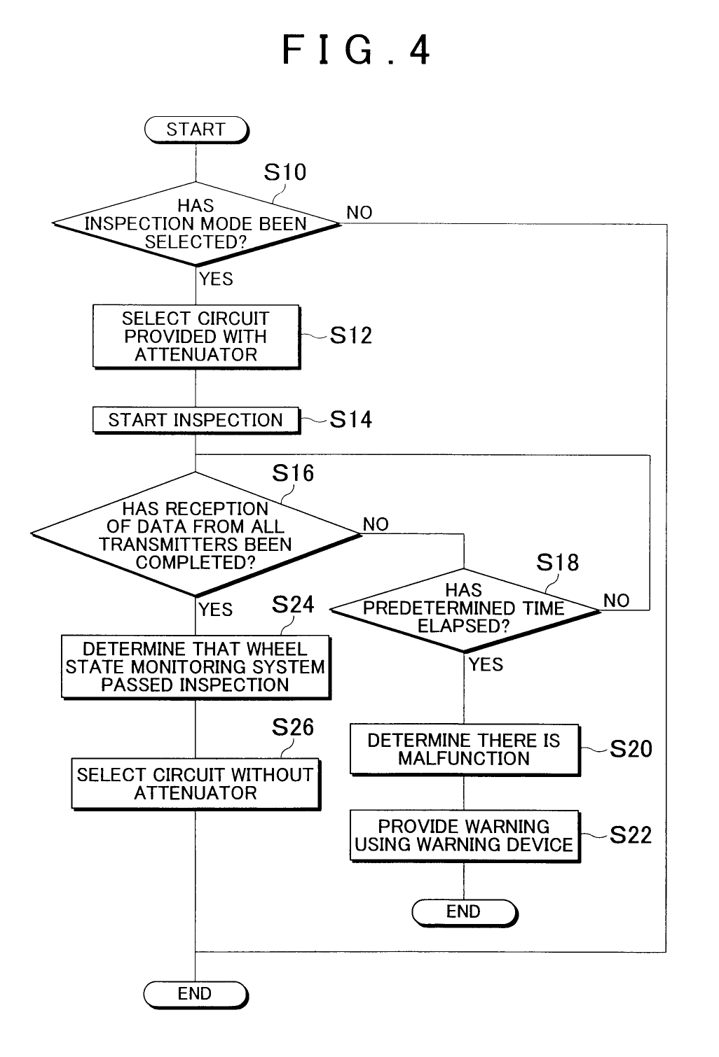

FIG. 4 is a flowchart for describing the method for inspecting the wheel state monitoring system according to the first embodiment of the invention. The routine in the flowchart starts when the receiver 18 including the ECU 36 is actuated. More specifically, a worker actuates the receiver 18 by connecting the diagnostic device (not shown) to the receiver 18 via the connector 22. At this time, the ECU 36 determines which of the monitoring mode and the inspection mode has been selected (S10). The monitoring mode is selected at normal times when the wheel state monitoring system monitors the wheel states. In the inspection mode, the inspection is performed to determine whether the wheel information is appropriately transmitted from the transmitters 16 to the receiver 18.

If it is determined that the inspection mode has not been selected (“NO” in S10), the routine ends. On the other hand, if the inspection mode has been selected in the diagnostic device and a signal indicating the inspection mode and the information containing the ID code of the transmitter 16, which is subjected to the inspection, are transmitted to the ECU 36, the ECU 36 determines that the inspection mode has been selected (“YES” in S10), and selects the circuit R2 provided with the attenuator 40 (see FIG. 3) using the switch 42 (S12). Then, the inspection is started (S14). Step S12 in the routine corresponds to a receiver sensitivity reduction step in which the sensitivity of the receiver 18 is reduced to a level below the receiver sensitivity available in the communication state selected at normal times. As a result, the inspection is performed in the state where it is more difficult for the receiver 18 to receive signals transmitted from the transmitters 16 and/or to determine whether the signals contain the wheel information than in the state of communication between the transmitters 16 and the receiver 18 at normal times. Even in the wheel state monitoring system including multiple transmitters 16, for example, the wheel state monitoring system according to the first embodiment of the invention, it is possible to change the states of communication between the receiver 18 and the respective transmitters 16 at once by just reducing the sensitivity of the receiver 18.

After the inspection is started, it is determined whether the receiver 18 has appropriately received signals containing the data of the wheel information transmitted from the transmitters 16 (S16). Signals containing the information including the tire-pressure and the ID codes are periodically transmitted from the transmitters 16 to the receiver 18. If reception of the data from all the transmitters 16 has not been completed at the receiver 18 (“NO” in S16), it is then determined whether a predetermined time has elapsed since the inspection is started (S18). If it is determined that the predetermined time has not elapsed (“NO” in S18), the receiver 18 is kept in a reception state so that the receiver 18 is able to receive signals transmitted from the transmitters 16. On the other hand, if it is determined that the predetermined time has elapsed (“YES” in S18), the ECU 36 determines that there is a malfunction in the transmitter 18 the data from which cannot be received by the receiver 18 (S20), and notifies the worker of the malfunction using the warning device 20 (S22). Based on the result of inspection, the worker replaces the defective transmitter or receiver with a new one or repairs such defective transmitter or receiver. This makes it possible to prevent any shipment of a defective wheel state monitoring system.

On the other hand, if it is determined that reception of the data from all the transmitters 16 has been completed (“YES” in S16), it is determined that the wheel state monitoring system including the receiver 18 has passed the inspection (S24). Subsequently, the ECU 36 selects the circuit R1, which is not provided with the attenuator 40, using the switch 42 (S26), thereby terminating the inspection mode.

With the method for inspecting the wheel state monitoring system according to the first embodiment of the invention, the inspection is performed in the state where signals of which the voltages are attenuated by the attenuator 40 are input in the vehicle body-side reception unit 34. Therefore, it is possible to sort out, as a rejected product, a wheel state monitoring system in which the wheel information is not always transmitted appropriately from the transmitters 16 to the receiver 18 depending on variations in the communication state caused by variations in the environment around the vehicle and use condition of the vehicle. In other words, with the method for inspecting the wheel state monitoring system according to the first embodiment of the invention, it is possible to pick up a wheel state monitoring system in which the wheel information is always transmitted appropriately from the transmitters 16 to the receiver 18 even when there are variations in the communication state caused by variations in the environment around the vehicle and use condition of the vehicle. Namely, according to the inspection method described above, it is possible to suppress occurrence of a situation in which the wheel information is not transmitted from the transmitters 16 to the receiver 18 when the wheel state monitoring system is in use. As a result, the accuracy of inspection is enhanced.

Furthermore, it is possible to perform an inspection on the receiver 18 to determine whether the performance and the specification of the receiver 18 meet predetermined requirements. In this case, a standard transmitter of which the performance apparently meets a predetermined requirement is used as the transmitter 16. In this way, it is possible to perform an inspection on the receiver itself in the state in which it is more difficult for the receiver 18 to receive signals transmitted from the transmitters and/or to determine whether the signals contain the wheel information than in the state of communication between the transmitters 16 and the receiver 18 at normal times. Therefore, if the receiver is not always able to receive the wheel information appropriately from the transmitters depending on variations in the communication states caused by variations in the environment around the vehicle and the use conditions of the vehicle, this receiver is sorted out as a rejected product. In other words, if the receiver is always able to receive the wheel information appropriately from the transmitters even when there are variations in the communication states caused by variations in the environment around the vehicle and the use conditions of the vehicle, this receiver is picked up as an accepted product.

### Second Embodiment of the Invention

According to the first embodiment of the invention, the communication state setting unit is provided in the receiver. In contrast, according to a second embodiment of the invention, a communication state setting unit is provided in each transmitter. A wheel state monitoring system according to the second embodiment of the invention is similar in the schematic structure to the wheel state monitoring system according to the first embodiment of the invention in FIG. 1. Therefore, descriptions of the common structures between the first embodiment and the second embodiment will not be provided below. Further, description of the common elements between the first embodiment and the second embodiment will not be provided below.

Receiver

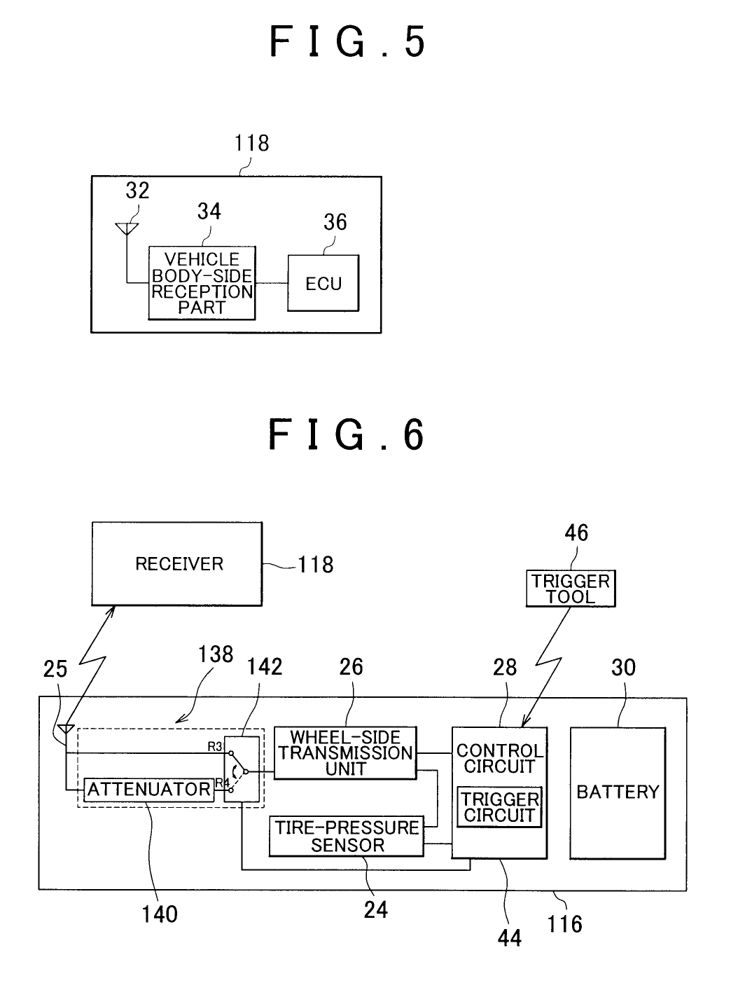

FIG. 5 is a block diagram showing a receiver 118 according to the second embodiment of the invention. The receiver 118 has the same structure as that of the receiver 18, except that the communication state setting unit 38 is not provided in the receiver 118 according to the second embodiment of the invention.

Transmitter

FIG. 6 is a block diagram showing a transmitter 1 16 according to the second embodiment of the invention. As in the transmitter 16 according to the first embodiment of the invention, in the transmitter 116 according to the second embodiment of the invention, the tire-pressure sensor 24, the antenna 25, the wheel-side transmission unit 26, the control circuit 28 and the battery 30 are housed. Arranged between the antenna 25 and the wheel-side transmission unit 26 is a communication state setting unit 138 that selects the state of communication between the transmitter 116 and the receiver 118 from among multiple communication states. The communication state setting unit 138 according to the second embodiment of the invention includes an attenuator 140 that attenuates the voltage of a signal containing the tire-pressure and the information including the ID code output from the wheel-side transmission unit 26 to create a simulated communication state in which it is more difficult for the receiver 118 to receive signal transmitted from the transmitter 116 and/or to determine whether the signal contain the wheel information. In this case, the attenuator 140 serves as a transmission power reduction unit that reduces the transmission power of the transmitter 116 to a level below the transmission power available in the communication state at normal times. Considering variations in the communication state caused by variations in the environment around the vehicle or use condition of the vehicle, an attenuator having a capacity of, for example, approximately 4 dB may be used as the attenuator 140.

The communication state setting unit 138 further includes a switch 142. The switch 142 selects the circuit, through which a signal that is from the wheel-side transmission unit 26 and output from the antenna 25 is transmitted, between a circuit R4 and a circuit R5. Through the circuit R4, a signal that is from the wheel-side transmission unit 26 and output from the antenna 25 is transmitted via the attenuator 140. Through the circuit R5, a signal that is from the wheel-side transmission unit 26 and output from the antenna 25 is transmitted without passing through the attenuator 140. The switch 142 is appropriately controlled by the control circuit 28 to select the state of communication between the transmitter 116 and the receiver 118 from among multiple communication states.

At normal times when the wheel state monitoring system according to the second embodiment of the invention monitors the wheel states, the switch 142 selects the circuit R3 through which a signal that is from the wheel-side transmission unit 26 and output from the antenna 25 is transmitted without passing through the attenuator 140. In this communication state, a signal is transmitted from the transmitters 116 to the receiver 118, and the ECU 36 in the receiver 118 determines the tire states based on the information received from the vehicle body-side reception unit 34. If the tire-pressure falls below a predetermined pressure or if the temperature of the air within the tire exceeds a predetermined temperature, the ECU 36 notifies the vehicle occupant of the tire state by actuating the warning device 20 to illuminate a warning lamp or to generate a warning beep using a buzzer.

Further, the transmitter 116 according to the second embodiment of the invention includes a trigger circuit 44 that actuates the tire-pressure sensor 24 and the control circuit 28 or changes the setting thereof upon reception of externally-transmitted radio waves. In the inspection method according to the second embodiment of the invention, when an inspection is performed on the wheel state monitoring system as in the first embodiment of the invention described above, the diagnostic device is connected to the receiver 118 and a switching signal, according to which the switch 142 selects the circuit, is transmitted to the trigger circuit 44 through the use of a trigger tool 46.

Based on the switching signal received by the trigger circuit 44, the control circuit 28 selects the circuit R4, through which a signal that is from the transmission unit 26 and output from the antenna 25 is transmitted via the attenuator 140, using the switch 142. This step corresponds to a transmission-power limiting step in which the transmission power of the transmitter 116 is reduced to a level below the transmission power available in the communication state at normal times. As a result, the inspection is performed in the state in which it is more difficult for the receiver 118 to receive signals transmitted from the transmitters 116 and/or to determine whether the signals contain the wheel information than in the state of communication between the transmitter 116 and the receiver 118 at normal times. Steps other than the transmission-power limiting step are substantially the same as steps S14 to S26 in the inspection method according to the first embodiment of the invention.

Because the method for inspecting the wheel state monitoring system according to the second embodiment of the invention includes the transmission-power limiting step as described above, it is possible to create a simulated communication state in which it is more difficult for the receiver 118 to receive signals transmitted from the transmitters 116 and/or to determine whether the signals contain the wheel information. In particular, the S/N (signal/noise) ratio of a signal that reaches the receiver 1 18 and read in the receiver 1 18 is lower than the S/N ratio in the case where the sensitivity of the receiver 18 is reduced as in the first embodiment of the invention. Therefore, the inspection is performed in a more rigorous communication state in which it is further difficult to establish communication between the transmitters and the receiver.

More specifically, if the sensitivity of the receiver 18 is reduced by the attenuator 40 as in the wheel state monitoring system according to the first embodiment of the invention, noise contained in the signal received by the antenna 25 is also reduced. Therefore, the S/N ratio at the vehicle body-side reception unit 34 does not change depending on whether the attenuator 40 is provided or not. In contrast, when the transmission power of the transmitter 116 is reduced by the attenuator 40 in the transmitter 116 as in the wheel state monitoring system according to the second embodiment of the invention, noise contained in the signal received by the antenna 25 of the receiver 118 is not attenuated. Therefore, the S/N ratio at the vehicle body-side reception unit 34 is smaller.

Therefore, with the method for inspecting the wheel state monitoring system according to the second embodiment of the invention, it is possible to pick up a wheel state monitoring system in which communication between the transmitters and the receiver is always established appropriately even when there are significant variations in the communication states caused due to variations in the environment around the vehicle and the use condition of the vehicle.

### Third Embodiment of the Invention

In a wheel state monitoring system according to a third embodiment of the invention, the wheel-side transmission unit 26 according to each embodiment of the invention described above is provided with a reception function and the reception unit 34 according to each embodiment of the invention is provided with a transmission function, whereby two-way communication is established between the transmitters and the receiver. With this configuration, the transmission power of the transmitter is changed based on a signal from the receiver. Therefore, the worker need not change the transmission power using the trigger tool as in the second embodiment of the invention. As a result, the efficiency of the inspection is enhanced.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the scope of the invention.

For example, the transmitter according to each embodiment of the invention is integrated with the tire-pressure regulating valve. Alternatively, the transmitter may be provided separately from the tire-pressure regulating valve. Furthermore, the communication state setting unit according to each embodiment of the invention is provided in the transmitter or the receiver. Alternatively, the communication state setting unit may be provided separately from the transmitter or the receiver, at a position between the antenna and the transmitter or the receiver.

What is claimed is:

1. A method for inspecting a wheel state monitoring system that monitors a state of a wheel using a transmitter that wirelessly transmits a signal containing wheel information on the wheel and a receiver that receives the signal and estimates the state of the wheel based on the wheel information, comprising:
performing an inspection to determine whether the wheel information is appropriately transmitted from the transmitter and received by the receiver in a communication state in which it is more difficult for the receiver to receive, as the wheel information, a signal transmitted from the transmitter than in a state of communication between the transmitter and the receiver, which is selected at normal times when the wheel state monitoring system monitors the state of the wheel.

2. The method according to claim 1, wherein the inspection is performed with a receiver sensitivity of the receiver reduced to a level below a receiver sensitivity in the communication state selected at normal times.

3. The method according to claim 1, wherein the inspection is performed with a transmission power of the transmitter reduced to a level below a transmission power in the communication state selected at normal times.

4. The method according to claim 2, wherein the receiver sensitivity of the receiver is reduced to a level below the receiver sensitivity in the communication state selected at normal times by attenuating a voltage of the signal received.

5. The method according to claim 1, further comprising:
determining that the transmitter malfunctions, when a state in which the signal is not received by the receiver has continued for a predetermined time.

6. A wheel state monitoring system that monitors a state of a wheel, comprising:
a transmitter that wirelessly transmits a signal containing wheel information on the wheel;
a receiver that receives the signal and estimates the state of the wheel based on the wheel information; and
a communication state setting unit that sets, when an inspection is performed to determine whether the wheel information is appropriately transmitted from the transmitter and received by the receiver, a communication state in which it is more difficult for the receiver to receive, as the wheel information, a signal transmitted from the transmitter than in a state of communication between the transmitter and the receiver, which is selected at normal times when the wheel state monitoring system monitors the state of the wheel.

7. The wheel state monitoring system according to claim 6, wherein the communication state setting unit includes a receiver sensitivity reduction unit that reduces a receiver sensitivity of the receiver to a level below a receiver sensitivity in the communication state selected at normal times.

8. The wheel state monitoring system according to claim 7, wherein the communication state setting unit is a unit that attenuates a voltage.

9. The wheel state monitoring system according to claim 6, wherein the communication state setting unit includes a transmission power limiting unit that reduces a transmission power of the transmitter to a level below a transmission power in the communication state selected at normal times.

10. The wheel state monitoring system according to claim 6, wherein the communication state setting unit is included in the receiver.

11. The wheel state monitoring system according to claim 6, wherein the communication state setting unit is included in the transmitter.

12. A receiver that receives a signal which contains wheel information on a wheel and which is wirelessly transmitted from a transmitter, and that estimates a state of the wheel, comprising:
a communication state setting unit that sets, when an inspection is performed to determine whether the wheel information is appropriately transmitted from the transmitter and received by the receiver, a communication state in which it is more difficult for the receiver to receive, as the wheel information, a signal transmitted from the transmitter than in a state of communication between the transmitter and the receiver, which is selected at normal times when the state of the wheel is monitored.

13. The receiver according to claim 12, wherein the communication state setting unit includes a receiver sensitivity reduction unit that reduces a receiver sensitivity of the receiver to a level below a receiver sensitivity in the communication state selected at normal times.

14. A transmitter that transmits a signal containing wheel information on a wheel to a receiver that receives the signal and that estimates a state of the wheel, comprising:
a communication state setting unit that sets, when an inspection is performed to determine whether the wheel information is appropriately transmitted from the transmitter and received by the receiver, a communication state in which it is more difficult for the receiver to receive, as the wheel information, a signal transmitted from the transmitter than in a state of communication between the transmitter and the receiver, which is selected at normal times when the state of the wheel is monitored.

15. The transmitter according to claim 14, wherein the communication state setting unit includes a transmission power limiting unit that reduces a transmission power of the transmitter to a level below a transmission power in the communication state selected at normal times.

16. A wheel state monitoring system that monitors a state of a wheel, comprising:
transmission means for wirelessly transmitting a signal containing wheel information on the wheel;
reception means for receiving the signal and estimating the state of the wheel based on the wheel information; and
communication state setting means for setting, when an inspection is performed to determine whether the wheel information is appropriately transmitted from the transmitter and received by the receiver, a communication state in which it is more difficult for the receiver to receive, as the wheel information, a signal transmitted from the transmitter than in a state of communication between the transmitter and the receiver, which is selected at normal times when the wheel state monitoring system monitors the state of the wheel.
